(19) United States
(12) Patent Application Publication
(10) Pub. No.: US 2017/0256876 A1
(43) Pub. Date: Sep. 7, 2017

(54) "8"-SHAPED ELASTIC CONTACT ELEMENT AND ELECTRICAL CONNECTOR USING SAID CONTACT ELEMENT

(71) Applicant: AVIC JONHON OPTRONIC TECHNOLOGY CO., LTD, Luoyang, Henan (CN)

(72) Inventors: Guoqi ZHOU, Luoyang, Henan (CN); Lei ZHANG, Luoyang, Henan (CN); Xiaoguang ZHANG, Luoyang, Henan (CN); Junfeng YUAN, Luoyang, Henan (CN)

(73) Assignee: AVIC JONHON OPTRONIC TECHNOLOGY CO., LTD, Luoyang, Henan (CN)

(21) Appl. No.: 15/507,047

(22) PCT Filed: Oct. 29, 2015
(86) PCT No.: PCT/CN2015/093252

§ 371 Date: Feb. 27, 2017

(30) Foreign Application Priority Data
Aug. 29, 2014 (CN) 201410434299.1

(51) Int. Cl. H01R 13/24

(52) U.S. Cl. CPC H01R 13/2435

(57) ABSTRACT

Disclosed are an “8”-shaped elastic contact element and an electrical connector using the contact element. The “8”-shaped elastic contact element comprises two contact parts in conductive contact with two corresponding connectors respectively and a connecting part (12) located between the two contact parts, the elastic contact element is formed by ending a strip-shaped conductive material, a fracture is formed between the two ends of the conductive material, the contact parts and the connecting part are arranged in an “8” shape, and each contact part has at least one arc-shaped contact structure which is bulged towards the periphery. Each bent part of the “8” shape of the elastic contact element forms a bending deformation structure to disperse the deformation process, thereby prolonging the servide life of the elastic contact element, and the elastic contact element, which is only formed by simple arcs, does not have a special requirement for materials.

### FIELD OF THE INVENTION

The present invention relates to the field of electrical connectors, and particularly, relates to an “8”-shaped elastic contact element and an electrical connector using said contact element.

### BACKGROUND

Adapters are common ones among electrical connectors, and can be divided into plug-in adapters and terminating adapters according to different contact modes. The terminating adapter realizes electrical connection via a jacking contact between the corresponding ends of a contact element and an adapter connector.

The contact elements for the terminating adapters are mostly elastic contact elements, and at present, the common elastic contact elements for the terminating adapters are mainly in the following three shapes: 1, C shape, shown in FIG. 1; 2, spatial V shape, shown in FIG. 2; and 3, helical spring shape, shown in FIG. 3.

Among the above three kinds of elastic contact elements, when the C-shaped and spatial V-shaped elastic contact elements are stressed during working, the bending points are single, so plastic deformation due to fatigue is easily produced and service lives are short; the requirement for materials for the helical spring-shaped elastic contact elements is relatively high, and the common copper material cannot provide enough elastic contact force, so special materials are needed and the manufacturing cost is relatively high; besides, relatively high loop inductance of helical springs is also unbeneficial to optimizing the performance of the adapters.

### SUMMARY

The aim of the present invention is to provide an “8”-shaped elastic contact element with low material requirement and long service life which is used for a terminating adapter.

Meanwhile, the aim of the present invention is also to provide an electrical connector using said elastic contact element.

In order to solve the above problems, the “8”-shaped elastic contact element of the present invention adopts the following technical solution: the “8”-shaped elastic contact element includes two contact parts in conductive contact with two corresponding connectors respectively and a connecting part located between the two contact parts, the elastic contact element is formed by bending a strip-shaped conductive material, a fracture is formed between the two ends of the conductive material, the elastic contact element is “8”-shaped, and each contact part has at least one arc-shaped contact structure which is bulged towards the periphery.

The conductive material is a plate or a band.

Transition parts between the connecting part and the contact parts are arc-shaped.

The electrical connector adopts the following technical solution: the electrical connector includes an insulating plate, the insulating plate is provided with penetrating mounting holes, elastic contact elements are fixedly assembled in the mounting holes, the elastic contact element includes two contact parts in conductive contact with two corresponding connectors respectively and a connecting part located between the two contact parts, the elastic contact element is formed by bending a strip-shaped conductive material, a fracture is formed between the two ends of the conductive material, the elastic contact element is “8”-shaped, and each contact part has at least one arc-shaped contact structure which is bulged towards the periphery.

The conductive material is a plate or a band.

Transition parts between the connecting part and the contact parts are arc-shaped.

The “8”-shaped elastic contact element is formed by bending a strip-shaped conductive material, a fracture is formed between the two ends of the conductive material, and the whole elastic contact element is “8”-shaped. Thus, each bent part of the “8” shape of the elastic contact element forms a bending deformation structure to disperse the deformation stress, thereby prolonging the service life of the elastic contact element, and the elastic contact element, which is only formed by simple arcs and the like, does not have a special requirement for materials.

### BRIEF DESCRIPTION OF THE DRAWINGS

FIG. 1 is a structural schematic diagram of a C-shaped elastic contact element;

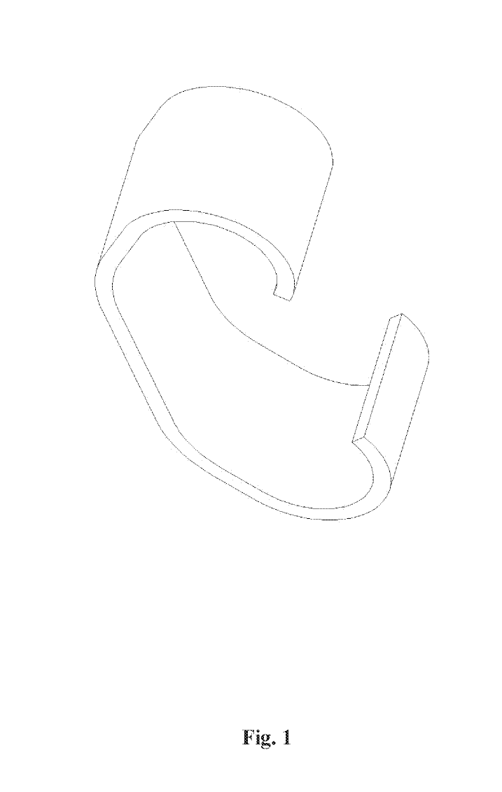

FIG. 2 is a structural schematic diagram of a spatial V-shaped elastic contact element;

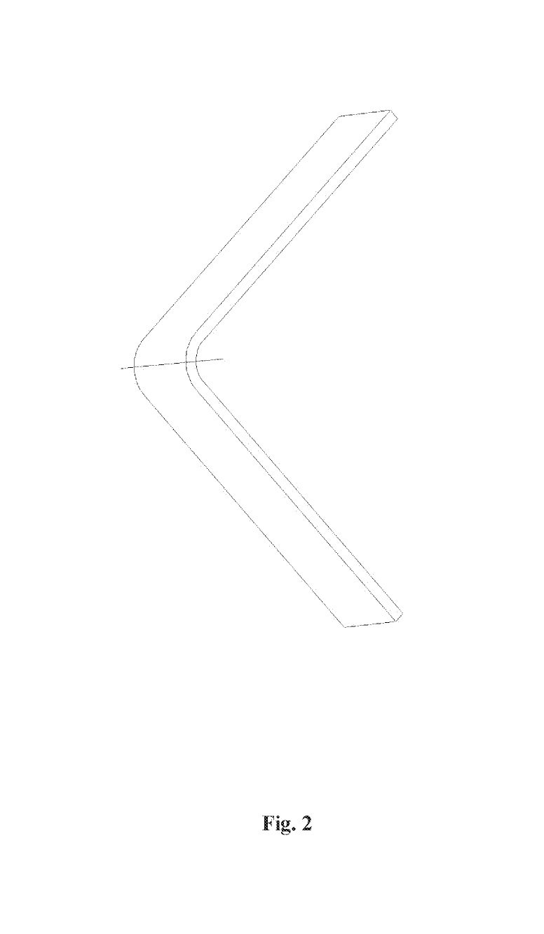

FIG. 3 is a structural schematic diagram of a helical spring-shaped elastic contact element;

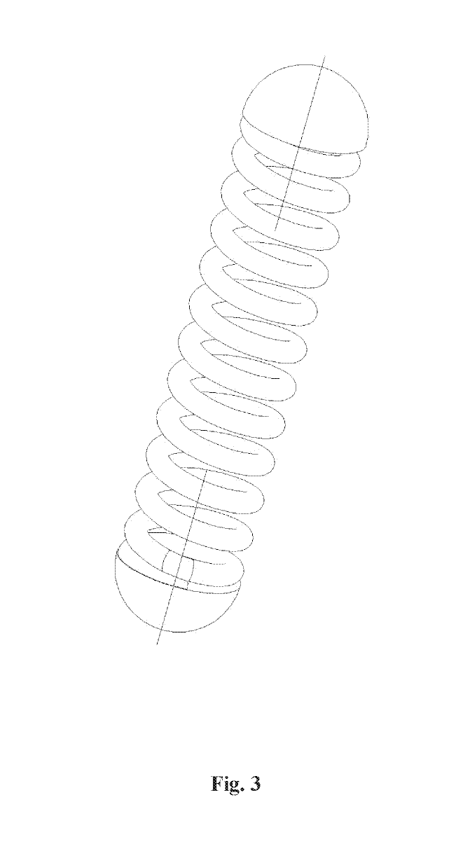

FIG. 4 is a structural schematic is diagram of embodiment 1 of an “8”-shaped elastic contact element;

FIG. 5 is a structural schematic diagram of embodiment 2 of an “8”-shaped elastic contact element;

FIG. 6 is a structural schematic diagram of embodiment 3 of an “8”-shaped elastic contact element;

FIG. 7 is a structural schematic diagram of embodiment 4 of an “8”-shaped elastic contact element;

FIG. 8 is a structural schematic diagram of embodiment 1 of an electrical connector;

FIG. 9 is a matching schematic diagram of an insulator in embodiment 1 of the electrical connector and elastic contact elements;

FIG. 10 is a structural schematic diagram of embodiment 2 of an electrical connector.

### DETAILED DESCRIPTION OF THE EMBODIMENTS

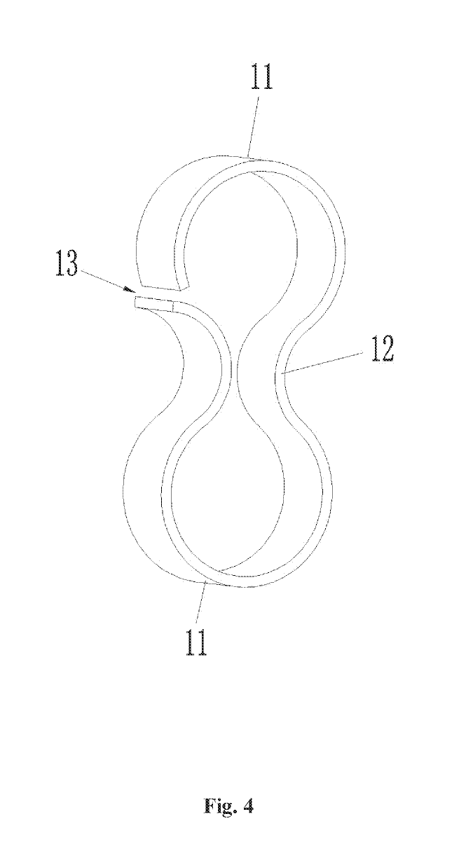

Embodiment 1 of an “8”-shaped elastic contact element is shown in FIG. 4, the elastic contact element is formed by bending a strip-shaped conductive material, the elastic contact element includes two contact parts 11 in conductive contact with corresponding connectors and a connecting part 12 located between the two contact parts, and the transition parts between the connecting part and the contact parts are arc-shaped. The whole elastic contact element is “8”-shaped. “The whole elastic contact element is ‘8’-shaped” indicates that the contact parts and the connecting part form a similar “8”-shaped structure. The two contact parts 11 are used for being respectively in conductive contact with two corresponding connectors to electrically connect the both, the connecting part is connected between the two contact parts, and in this embodiment, each contact part has only one arc-shaped contact structure which is bulged towards the periphery.

Because the elastic contact element is formed by bending a strip-shaped conductive material, a fracture 13 is formed on the elastic contact element, the fracture 13 is located between the two ends of the conductive material, in this embodiment, the fracture is located on one of circles of the “8” shape of the elastic contact element, and the conductive material is a plate material, i.e., a conductive band.

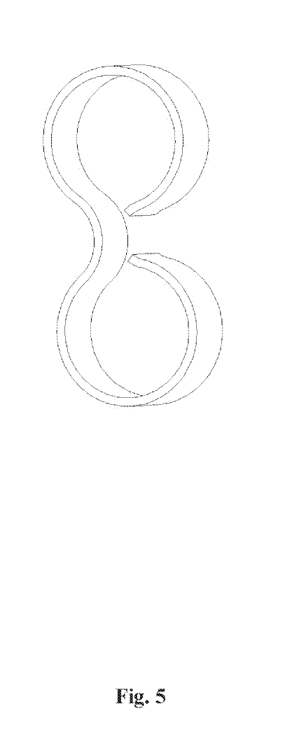

Embodiment 2 of an “8”-shaped elastic contact element is shown in FIG. 5, and this embodiment differs from embodiment 1 of the above-mentioned “8”-shaped elastic contact element only in that the fracture is located at the adjacent position of the two circles of the “8” shape of the elastic contact element.

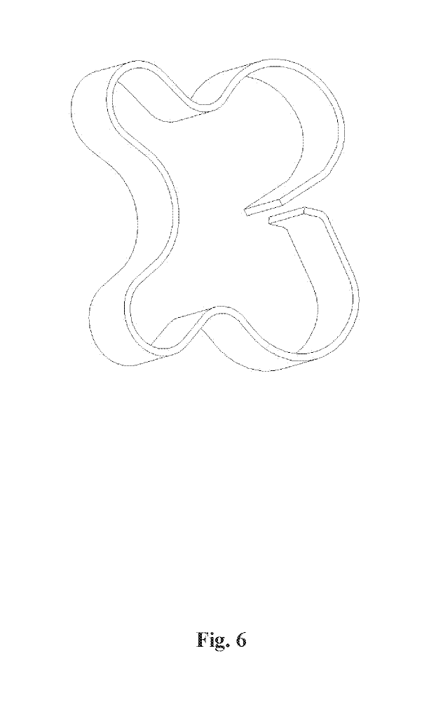

Embodiment 3 of an “8”-shaped elastic contact element is shown in FIG. 6, and this embodiment differs from embodiment 2 of the above-mentioned “8”-shaped elastic contact element only in that each contact part has two arc-shaped contact structures which are bulged towards the periphery.

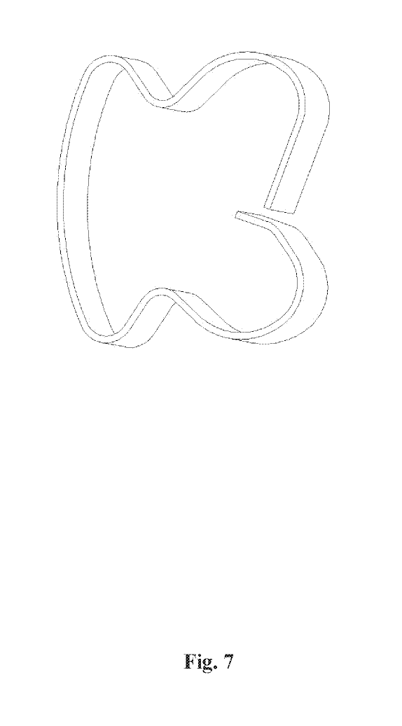

Embodiment 4 of an “8”-shaped elastic contact element is shown in FIG. 7, and this embodiment differs from embodiment 3 of the above-mentioned “8”-shaped elastic contact element only in that the arc-shaped and inward bent part is removed from the connecting part, so that the contact element forms an “8” shape lying on one side.

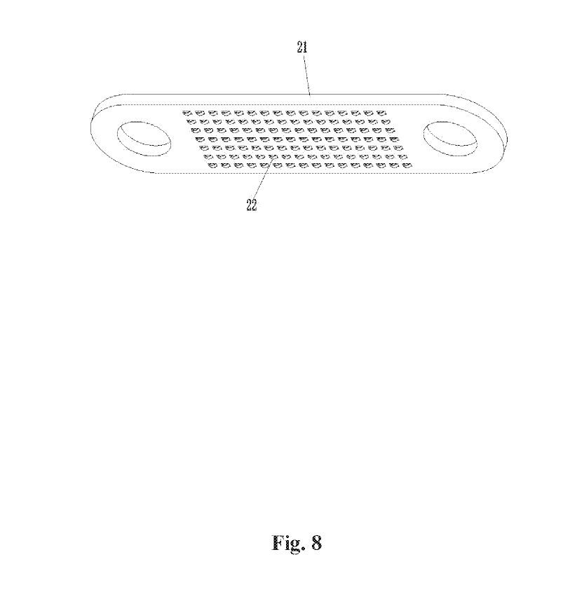

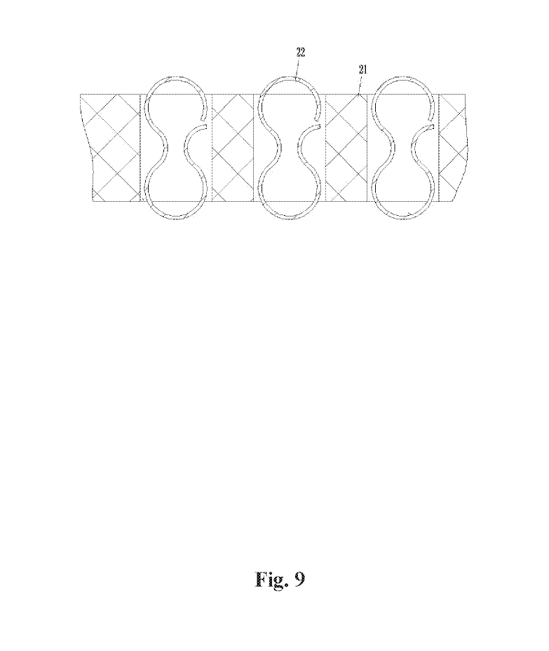

Embodiment 1 of an electrical connector is shown in FIGS. 8-9, the electrical connector includes an insulating plate 21 and elastic contact elements 22, the insulating plate 21 is provided with mounting holes, the elastic contact elements 22 are fixedly assembled in the corresponding mounting holes, and in this embodiment, the structure of the elastic contact elements 22 is the same as that of embodiment 1 of the above-mentioned elastic contact element and is thus not redundantly described herein.

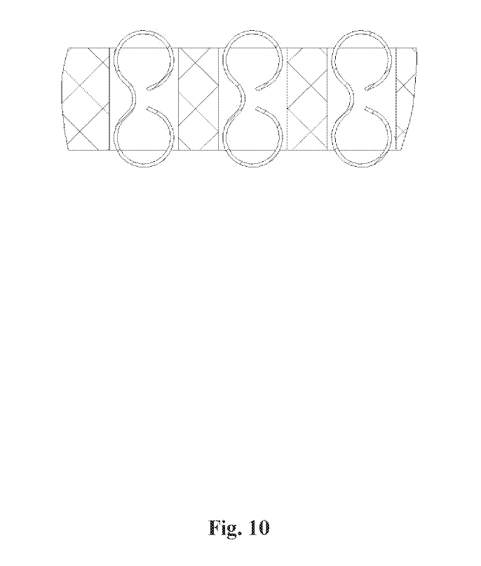

Embodiment 2 of an electrical connector is shown in FIG. 10, and this embodiment differs from embodiment 1 of the above-mentioned electrical connector only in that the structure of the contact elements is the same as that of embodiment 2 of the above-mentioned “8”-shaped elastic contact element.

In other embodiments of the electrical connector, contact elements can also be of a hybrid structure of embodiments 1, 2, 3 and 4 of the above-mentioned “8”-shaped elastic contact element.

1. An “8”-shaped elastic contact element, including two contact parts in conductive contact with two corresponding connectors respectively and a connecting part located between the two contact parts, wherein the elastic contact element is formed by ending a strip-shaped conductive material, a fracture is formed between the two ends of the conductive material, the elastic contact element is “8”-shaped, and each contact part has at least one arc-shaped contact structure which is bulged towards the periphery.

2. The “8”-shaped elastic contact element as forth in claim 1, wherein the conductive material is a plate or a band.

3. The “8”-shaped elastic contact element as set forth in claim 1, wherein transition parts between the connecting part and the contact parts are arc-shaped.

4. An electrical connector, including an insulating plate, the insulating plate is provided with penetrating mounting holes, elastic contact elements are fixedly assembled in the mounting holes: the elastic contact element includes two contact parts in conductive contact with two corresponding connectors respectively and a connecting part located between the two contact parts, wherein the elastic contact element is formed by bending a strip-shaped conductive material, a fracture is formed between the two ends of the conductive material, the elastic contact element is “8”-shaped, and each contact part has at least one arc-shaped contact structure which is bulged towards the periphery.

5. The electrical connector as set forth in claim 4 wherein the conductive material is a plate or a band.

6. The electrical connector as set forth in claim 4, wherein transition parts between the connecting part and the contact parts are arc-shaped.

7. The “8”-shaped elastic contact element as set forth in claim 2, wherein transition parts between the connecting part and the contact part are arc-shaped.

8. The electrical connector as set forth m claim 5, wherein transition parts between the connecting part and the contact parts are arc-shaped.
